(19) United States
(12) Patent Application Publication
(10) Pub. No.: US 2012/0006665 A1
(43) Pub. Date: Jan. 12, 2012

(54) GAS-INSULATED SWITCHGEAR ASSEMBLY

(75) Inventors: Diego SOLOGUREN-SANCHEZ, Wettingen (CH); Tilo Bolli, Merligen (CH)

(73) Assignee: ABB Technology AG, Zurich (CH)

(21) Appl. No.: 13/170,725

(22) Filed: Jun. 28, 2011

(30) Foreign Application Priority Data
Jul. 9, 2010 (EP) 10169067.5

(51) Int. Cl. H01H 9/26

(52) U.S. Cl. 200/5 A

(57) ABSTRACT

A gas-insulated switchgear assembly is provided. The gas-insulated switchgear assembly includes at least one busbar which defines an axial direction. The busbar includes encapsulation which surrounds at least one nominal conductor. The encapsulation includes at least one pair of axially adjacent modules which are connected to one another via a compensation unit. The pair of modules are attached by at least one tie rod, which extends in the axial direction and is attached to a first attachment point of the first module and to the second attachment point of the second module. A thermal change in the length in the axial direction of the at least one tie rod between the first attachment point and the second attachment point, a thermal change in the axial direction in the distance between the first attachment point of the first module and the first reference point, and a thermal change in the axial direction in the distance between the second attachment point of the second module and the second reference point are at least partially compensated for such that the module distance changes by less than a predetermined amount in the axial direction when the encapsulation is heated or cooled.

### RELATED APPLICATION

This application claims priority under 35 U.S.C. §119 to European Patent Application No. 10169067.5 filed in Europe on Jul. 9, 2010, the entire content of which is hereby incorporated by reference in its entirety.

### FIELD

The present disclosure relates to a gas-insulated switchgear assembly, such as a gas-insulated switchgear assembly for transmission of primary powers in the medium-voltage and/or high-voltage range, for example.

### BACKGROUND INFORMATION

Gas-insulated switchgear assemblies (GIS) can include a plurality of switches, which are electrically connected to one another via so-called busbars for transmission of electrical primary power. Both single-phase-encapsulated and polyphase-encapsulated busbars are known. A single-phase busbar generally means a primary conductor which is arranged in its own encapsulation, in the form of a metal-encapsulated housing, by means of an insulation gas. In contrast to single-phase-encapsulated busbars, in the case of polyphase—for example, three-phase—encapsulated busbars, the primary conductors of different electrical phases are arranged jointly in a single metal-encapsulated housing.

Depending on the embodiment of the GIS, for example, in the form of a high-voltage assembly, the switches are arranged in different switch panels. A plurality of switch panels are connected to one another via single-phase or polyphase-encapsulated busbars. The busbar generally extends transversely with respect to the switch panels, for compactness of the GIS. In one widely used GIS assembly concept, each switch panel includes a longitudinal section of the busbar or busbars which extends in the axial direction, with the axial direction being defined by the cylindrical busbar. Busbar sections such as these are also referred to as busbar modules. In this case, the encapsulation of the busbar modules generally has at least one outgoer, which runs transversely with respect to the axial direction, for each switch panel, through which outgoer one connecting conductor leads to the respective circuit breaker for each phase.

The busbar modules are in this case firmly connected to a foundation via the switch panels. In other words, the switch panels, together with their busbar modules, are arranged at a fixed distance from one another. Depending on the embodiment, a compensation unit is arranged between each of the busbar modules of a busbar, and compensates for thermal expansion of individual modules of the busbar relative to one another. In order to allow thermal expansion of individual modules relative to one another, the encapsulation of the busbar is interrupted locally, but nevertheless in a gas-tight manner, in the area of the compensation units. This is often achieved by two tubular sections which can be pushed one inside the other and each have a flange section at one of their ends for mechanical attachment of the adjacent compensation units, thus resulting in an encapsulation section which can move in the axial direction. The compensation units therefore have a variable length in the axial direction. Furthermore, the insulation gas in the compensation units and in the busbar modules is at a predetermined gas pressure. When the busbar, which is formed from busbar modules and compensation units, is heated, the encapsulation sections of the busbar modules expand in the axial direction. In the case of two adjacent busbar modules/modules which are mechanically connected to one another, this thermal expansion leads to forces which have an opposite direction component in the axial direction. In consequence, the two busbar modules/modules are moved apart from one another, if the busbar modules are firmly connected to one another at their mutually facing ends, for example, directly or via a tie rod. This can lead to severe stresses and can load an anchorage for the switch panels in the foundation.

Appropriate measures must therefore be provided to prevent this. When the gas volume in the compensation unit is heated, this results only in forces caused by the gas pressure on surfaces of the busbar modules/modules which the gas is in contact with. However, due to the variable-length housing of the compensation units, no forces acting in the axial direction occur because of thermal expansion of their variable-length housing, because thermal expanded sections of the housing slide over one another.

Since the forces on the encapsulation side or housing side, which forces caused by the thermal expansion of the busbar modules/modules are many times greater than the forces caused by the heating of the gas, the compensation of the former is of major importance.

A plurality of compensation methods are known in order to counteract the abovementioned resultant thermal expansion forces.

By way of example, DE 10 2007 038 934 A1 discloses a first method which involves a compensation unit. In this compensation unit, an expansion area is provided to hold an amount of gas such that, when the tubular longitudinal section changes length, the sum of the volumes of the compensation area in the tubular longitudinal section and of the expansion area remains approximately constant, as a result of which no problematic resultant gas-pressure forces occur, and the forces resulting from thermal expansion of the connecting modules cannot act against one another.

Although this method can compensate for gas pressure changes and can suppress the effectiveness of the resultant forces caused by thermal expansion of the connecting modules, because of the change in the length of the compensation bellows, this leads to considerable complexity, however, because of the relatively complex and complicated design.

In a second method, tie rods are used to absorb the resultant forces which occur because of thermal expansion of the encapsulation. By way of example, EP 0 093 687 A1 is representative of this method. EP 0 093 687 A1 discloses a compressed-gas-insulated high-voltage switchgear assembly having a busbar system and switch panels in which outgoers from the busbar, and its encapsulation/housing, are anchored in a fixed position with respect to a foundation of the GIS. In this case, the busbar is split between two parallel axes, in order to break up the overall expansion of the busbar, and the forces resulting from it. In addition, in order to achieve force decoupling for busbar thermal expansion forces caused by the gas pressure, each outgoer is connected via a compensation bellows to the connecting modules and busbar modules, as a result of which the busbar is effectively floating with respect to the fixed-position outgoer. For this purpose, a tie rod is arranged such that it covers both compensation bellows and the outgoer located between them. In consequence, thermal expansion of the encapsulation of the busbar sections does not create any resultant forces on the outgoer and its attachment to the foundation.

This compensation solution takes up a large amount of space because of the zigzag-like constricted busbar. Furthermore, this arrangement is complicated to produce, requires two compensators for each outgoer and does not compensate for the thermal expansion of the encapsulation, but overcomes this by the zigzag-like configuration of the busbar.

### SUMMARY

An exemplary embodiment of the present disclosure provides a gas-insulated switchgear assembly which includes at least one busbar for transmission of electrical primary power. The busbar defines an axial direction and includes an encapsulation which surrounds at least one nominal conductor. The encapsulation includes at least one pair of axially adjacent modules of which a first module of the pair of axially adjacent modules has a first reference point in the axial direction, and a second module of the pair of axially adjacent modules has a second reference point in the axial direction. The encapsulation also includes a compensation unit which is arranged between each of the modules of the pair of axially adjacent modules, and a module separation which is defined by the axial distance between the first reference point and the second reference point of the respective pair of axially adjacent modules. In addition, the encapsulation includes at least one tie rod which is associated with the pair of axially adjacent modules and extends in the axial direction. The at least one tie rod is attached at a first attachment point to the first module and at a second attachment point to the second module, and has a length in the axial direction which extends between the first attachment point and the second attachment point. The at least one tie rod is configured to axially expand to at least partially compensate for any lengthening of the modules in the axial direction when the encapsulation is heated or cooled, due to the length of the at least one tie rod and a coefficient of linear expansion of the at least one tie rod in conjunction with a first distance which extends in the axial direction between the first attachment point and the first reference point of the first module, and a second distance which extends in the axial direction between the second attachment point and the second reference point of the second module, as well as coefficients of linear expansion of the adjacent modules.

### BRIEF DESCRIPTION OF THE DRAWINGS

Additional refinements, advantages and features of the present disclosure are described in more detail below with reference to exemplary embodiments illustrated in the drawings, in which:

FIG. 1 shows a schematic cross-sectional side view of an exemplary embodiment of a gas-insulated switchgear assembly without a nominal conductor;

FIG. 2 shows a schematic cross-sectional plan view of an exemplary embodiment of a gas-insulated switchgear assembly according to the present disclosure;

FIG. 3 shows a schematic graph of the thermal increase in the module separation in accordance with an exemplary embodiment of the present disclosure; and

FIG. 4 shows a schematic graph of the thermal increase in the module separation in accordance with an exemplary embodiment of the present disclosure.

### DETAILED DESCRIPTION

Exemplary embodiments of the present disclosure provide a switchgear assembly in which the resultant forces which occur, in addition to the gas pressure forces because of thermal expansion of the encapsulation, are essentially compensated for in a relatively simple manner, thus making it possible to produce a busbar which is continuous in the axial direction.

In accordance with an exemplary embodiment, a gas-insulated switchgear assembly (GIS) includes at least one busbar which defines an axial direction and includes encapsulation. The encapsulation includes at least one pair of axially adjacent modules, wherein the first module of the pair of axially adjacent modules has a first reference point in the axial direction, which can be held in a fixed position, and the second module of the pair of axially adjacent modules has a second reference point in the axial direction, which can be held in a fixed position. The encapsulation also includes a compensation unit which is arranged between each of the modules of a pair of axially adjacent modules, at least one module separation, which can be kept constant, and a module separation, which is defined by the axial distance between the first reference point and the second reference point of the respective pair of axially adjacent modules. The encapsulation also includes at least one tie rod which is associated with the pair of axially adjacent modules and extends in the axial direction. The tie rod is attached at a first attachment point to the first module and at a second attachment point to the second module, with a thermal change in a length in the axial direction of the at least one tie rod between the first attachment point and the second attachment point, a thermal change in the axial direction of the distance between the first attachment point of the first module and the first reference point, and a thermal change in the axial direction in the distance between the second attachment point of the second module and the second reference point at least partially compensating for one another, such that the module separation changes by less than a predetermined amount in the axial direction when the encapsulation is heated or cooled.

As used herein, the term “encapsulation” means the entire encapsulation of the busbar.

A first advantage of this exemplary GIS is that the forces resulting from the gas pressure and the thermal expansion of the modules of the encapsulation of the busbar can be compensated for without any need for an extremely complex compensation device for this purpose, such as that according to DE 10 2007 038 934 A1.

A second advantage is that the exemplary GIS makes it possible to avoid cumbersome, zigzag-like configurations of the busbar as in EP 0 093 687 A1, in that the GIS according to exemplary embodiments of the present disclosure allows the forces which occur as a result of thermal expansion to be absorbed to a very great extent, even with the busbar having a linear configuration.

In this case, the thermal changes in the tie rod, the first module between the first attachment point and the first reference point, and the second module between the second attachment point and the second reference point are in a fixed ratio with respect to one another. For example, in accordance with an exemplary embodiment, the at least one tie rod may be at essentially the same temperature as the first module between the first attachment point and the first reference point, and the second module between the second attachment point and the second reference point.

Compensation for the thermal change, for example an expansion, in the axial direction means, for example, that the thermal change in the tie rod between the first attachment point and the second attachment point, the thermal change in the axial direction in the distance between the first attachment point of the first module and the first reference point, and the thermal change in the axial direction in the distance between the second attachment point of the second module and the second reference point do not reinforce one another in opposite senses in such a way that the thermal changes cause an increased change in the module separation.

For example, the predetermined amount in the axial direction is less than the length change of the sum of the distance between the first attachment point of the first module and the first reference point, and the distance between the second attachment point of the second module and the second reference point.

In accordance with an exemplary embodiment, the materials and the attachment points are chosen such that the module separation has as little fluctuation range as possible when the temperatures of the encapsulation and of the tie rods change.

In accordance with an exemplary embodiment, which can be combined with other embodiments, the tie rod is rigid, such that the thermal change in the axial direction of the tie rod is based on the thermal characteristics of the at least one material of the tie rod. For example, the thermal change in the axial direction can be based only on the thermal characteristics of the at least one material of the tie rod.

In accordance with an exemplary embodiment, the length of the at least one tie rod which is associated with the pair in the axial direction between the first and the second attachment points is greater than the module separation of the pair, with thermal expansion in the axial direction by the at least one tie rod at least partially compensating for a thermal expansion in the axial direction of the modules.

The choice of a tie rod having a length between the attachment points which is greater than the module separation means that, when the material of the modules of the encapsulation is heated, the separation between the attachment points is increased in the same way that the length of the tie rod is also lengthened, even if the reference points are held in a fixed position. This makes it possible to, for example, ensure that the thermal expansion in the axial direction of the modules of the encapsulation and the thermal expansion of the tie rod are matched to one another.

In accordance with an exemplary embodiment, the module separation can change by less than 1%, for example, by less than 0.5%, when there is a temperature difference of 50° Celsius, for example, between the first and the second module and the tie rod. Such a minor change in the module separation avoids the possibility of the switch panels being stressed and torn out of the foundations.

In accordance with an exemplary embodiment, the gas-insulated switchgear assembly is filled with an insulating gas, for example, sulfur hexafluoride (SF₆), which is pressurized. The pressure can also increase as a result of the parts that carry current being heated. The pressure at 20° Celsius may be greater than 2.5 bar, for example, greater than 4 bar. The influence of the force increase as the insulating gas is heated is, to a first approximation, negligible in comparison to the force increase resulting from the thermal expansion of the encapsulation.

In accordance with an exemplary embodiment, the at least one material of the encapsulation and/or of the module of the encapsulation which contributes to thermal expansion in the axial direction, and the at least one material of the tie rod which contributes to thermal expansion in the axial direction, can be chosen such that, when the encapsulation and the tie rod are heated by 50° Celsius, the module separation changes by less than 1%, for example, by less than 0.5%. For example, the materials can be chosen such that the coefficient of expansion in the axial direction is defined. For example, the coefficient of expansion of the material of the encapsulation in the axial direction is greater than the coefficient of expansion of the at least one material of the tie rod in the axial direction, if the length of the tie rod in the axial direction between the first attachment point and the second attachment point is greater than the module separation. Both the encapsulation and the tie rod may be composed of a composite material. Depending on the nature and embodiment of the composite material, this can absorb greater tensile forces, with similar dimensions, than would be the case, for example, with an embodiment composed of steel.

In accordance with an exemplary embodiment, the coefficient of expansion in the axial direction of the at least one material of the tie rod may be negative, if the length of the tie rod in the axial direction between the first attachment point and the second attachment point is less than the module separation.

In accordance with an exemplary embodiment, thermal expansion in the axial direction of the encapsulation between the first reference point and the first attachment point and between the second reference point and the second attachment point, and thermal expansion in the axial direction of the at least one tie rod between the first and the second attachment points compensate for one another such that, when heated by 50° Celsius, the module separation changes by less than 1%, for example, by less than 0.5%.

For example, in accordance with an exemplary embodiment, the modules of the pair each have an axial section which is averted from their reference point on the compensation unit, wherein the at least one tie rod is in each case attached to the axial section or to the reference point at an attachment point. For example, the first attachment point can be arranged at the first reference point and the second attachment point can be arranged at the axial section of the second module of the pair of axially adjacent modules. Conversely, the second attachment point can be arranged at the second reference point and the first attachment point can be arranged at the axial section of the first module of the pair of axially adjacent modules.

Furthermore, in accordance with an exemplary embodiment, the reference point of each module can be arranged in the center in the axial direction of the module.

In accordance with an exemplary embodiment, the at least one tie rod can be arranged outside the gas area of the first and of the second module of the pair of axially adjacent modules. This makes it possible to make use of the waste heat from the encapsulation, in order to keep the at least one tie rod at the same temperature as the encapsulation or the module of the encapsulation. Furthermore, the tie rod can then be fitted more easily.

In accordance with an exemplary embodiment, at least one of the attachment points can be arranged at an axial end of the respective module of the encapsulation. This allows the tie rod to have a maximum length.

In accordance with an exemplary embodiment, the separation between the first attachment point and the first reference point of the first module and the separation between the second attachment point and the second reference point of the second module are the same, or substantially the same. This allows a simple design, and an uncomplicated configuration of the switchgear assembly.

In accordance with an exemplary embodiment, the busbar modules and their encapsulation sections may be connected in a fixed position to a foundation, directly or indirectly by other components of the switch panel, for example, in the area of the reference points.

Furthermore, in accordance with an exemplary embodiment, the modules may contain at least one switch.

In accordance with an exemplary embodiment, the gas in the at least two modules and/or the compensation unit may be at a pressure of more than 2.5 bar, for example, at a pressure of more than 4 bar, at 20° C.

Furthermore, in accordance with an exemplary embodiment, aluminum in the first and/or the second module, for example, in the pair of axially adjacent modules, of the encapsulation contributes to the change in the length in the axial direction.

Furthermore, in accordance with an exemplary embodiment, steel contributes to variation of the length in the axial direction in the at least one tie rod.

Alternatively or in addition to this, the tie rod is at least partially of composite construction. In accordance with an exemplary embodiment, carbon fiber materials which are oriented in the axial direction are joined together by a cement to form a composite material, in order to allow the resultant longitudinal forces in the axial direction or in the running direction of the busbar to be absorbed optimally. For mechanical linking to the busbar modules, the composite material can be, for example, connected at the end to metallic connecting elements, for example in the form of eyes. The use of one or even more composite materials makes it possible, for example, to precisely define in advance the expansion and force absorption behavior of the tie rod. It is therefore possible to produce tie rods which have characteristics which have not been possible to achieve until now by using purely metallic materials.

The use of tie rods composed of composite materials allows the attachment points to be arranged more freely on the modules. Furthermore, composite materials often cost less and have a lower mass.

Furthermore, in accordance with an exemplary embodiment, the at least one compensation unit can compensate for an axial thermal length change of at least one module section, which faces the reference point, of the modules of the pair relative to one another. For example, both a module section which faces the second module from the first reference point and a module section which faces the first module from the second reference point expand, the expansion in the axial direction of the compensation unit is reduced. For example, this can be achieved by means of encapsulation sections which slide over one another.

Furthermore, in accordance with an exemplary embodiment, the switchgear assembly can have more than two modules which are arranged axially one behind the other, wherein two axially adjacent modules in each case form a pair.

In accordance with an exemplary embodiment, the tie rods can be arranged over the encapsulations, that is to say from the encapsulations in the opposite direction to the direction of the earth's force of attraction. The temperature difference between the encapsulation and the tie rod is then less since, for example, the air which has been heated by the encapsulation or housing flows past the tie rod.

In accordance with an exemplary embodiment, the tie rod has no spring element that provides springing in the axial direction.

Further advantages, features, aspects and details of the disclosure as well as exemplary embodiments and special aspects of the disclosure will become evident from the claims, the description and the figures.

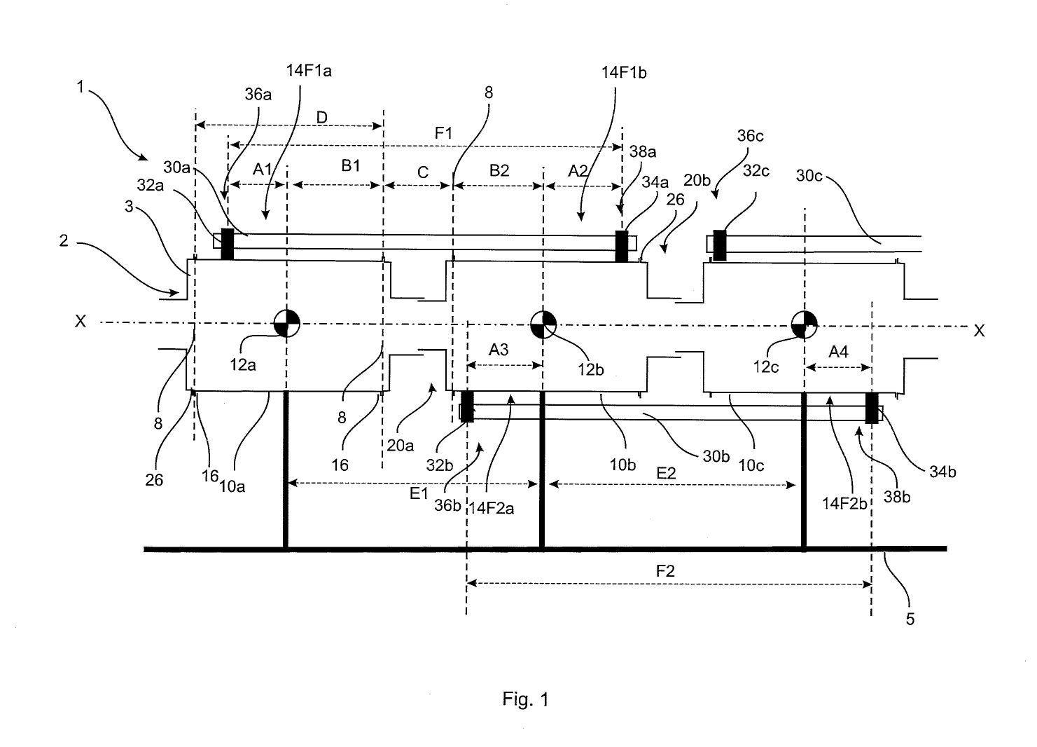

FIG. 1 shows a schematic cross-sectional side view of a section of an exemplary embodiment of a gas-insulated switchgear assembly 1 of the present disclosure. The switchgear assembly 1 has an encapsulation 3. By way of example, the encapsulation 3 may be formed from an aluminum casting or an aluminum alloy, or a composite material. No nominal conductor and no insulators are shown in FIG. 1.

A plurality of (high-voltage) switch panels of gas-insulated switchgear assemblies can be arranged parallel and are electrically and mechanically connected to one another with a busbar, which may be arranged at substantially right angles to the switch panels. Mechanically, a section or busbar module may be a part of a switch panel, and may be firmly connected to the switch panel.

By way of example, the section shown in FIG. 1 may be a busbar 2 of a gas-insulated switchgear assembly 1. The subject matter of the disclosed embodiments may also cover other sections of a switchgear assembly, by a busbar. Although the example shown in FIG. 1 illustrates a single-phase-encapsulated busbar 2, the technical teaching intrinsic to this disclosure also applies in a corresponding manner to a polyphase-encapsulated busbar. In the case of the latter, each nominal conductor can be surrounded in the area between two busbar modules by its own compensation unit, in such a way that, in the end, it has single-phase encapsulation in this area.

The encapsulation 3 of the busbar 2 includes a multiplicity of modules 10a, 10b, 10c, which are arranged one behind the other along an axis X (e.g., an axial direction), that is to say aligned with respect to the nominal conductor of one phase. In accordance with an exemplary embodiment, the axis X also corresponds to the axis of a nominal conductor in the case of a single-phase-encapsulated busbar 2. FIG. 1 shows three modules. The switchgear assembly according to an exemplary embodiment may also have only two modules which are arranged one behind the other on the axis X, or else more than three modules which are arranged one behind the other on the axis X. The modules have a module length D between their two ends in the axial direction, on each of which a connecting level 8 is arranged, in order to connect a further module or a compensation unit.

The modules 10a, 10b, 10c of the encapsulation are arranged on a foundation 5, and are connected in a fixed position to the foundation, for example indirectly via a high-voltage switch.

The respective compensation unit 20a, 20b is arranged between each two axially adjacent modules 10a, 10b; 10b, 10c of the encapsulation 3. For example, adjacent switch panels can therefore be connected via the compensation units 20a, 20b between the modules 10a, 10b, 10c of the encapsulation. Depending on the embodiment, the compensation units 20a, 20b can furthermore be used to simplify this assembly of the gas-insulated switchgear assembly, without having to remove a large proportion of the switch panels. The compensation units 20a, 20b therefore have a variable length C in the axial direction X. In accordance with an exemplary embodiment, the variable length can be achieved by two cylinders, which have a different diameter, being pushed one over the other.

By way of example, in accordance with an exemplary embodiment, the modules 10a, 10b, 10c each have a flange 16 at their axial ends. The flange 16 is firmly connected to a flange 26 on the respective axial ends of the compensation units 20a, 20b. The flanges on the modules 10a, 10b, 10c of the encapsulation and the flanges on the compensation units 20a, 20b may each be circular.

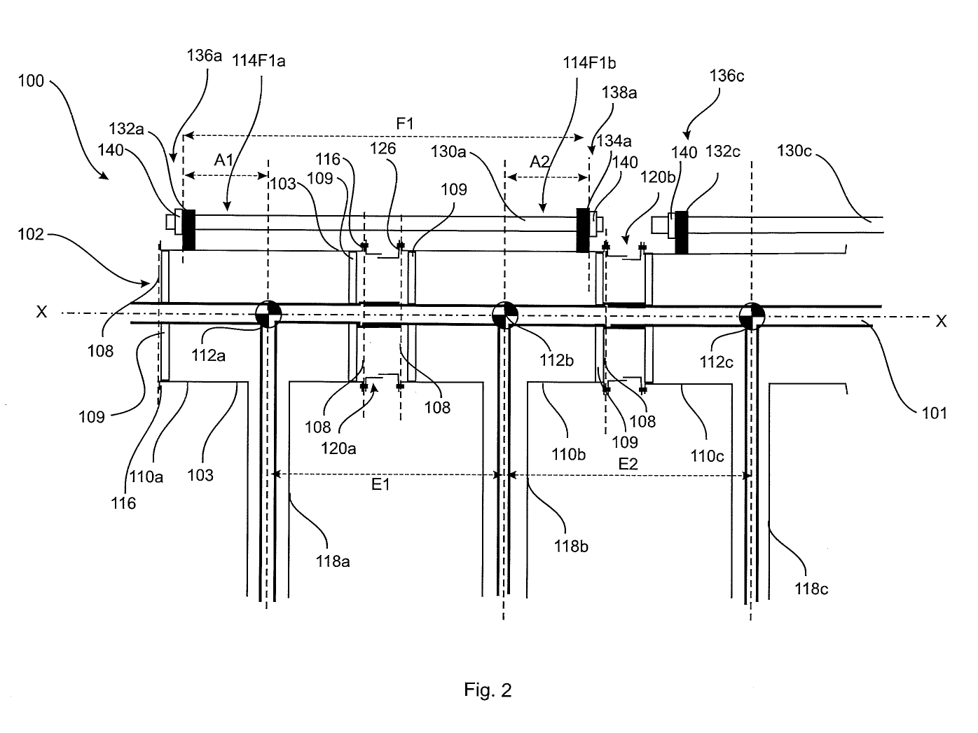

Insulators 109 (see FIG. 2) can be arranged on the connecting levels 8 between the compensation units 20a, 20b and the modules 10a, 10b, 10c, and are fitted with active parts, for example a nominal conductor 101 (see FIG. 2). The insulators 109 can split the busbar 2 into various gas compartments, depending on the requirement and the maintenance concept, by being in the form of supporting insulators or partition insulators, for example.

The gas pressure in the compensation unit 20a, 20b leads to forces when the gas area in the compensation units is separated from the gas area in the modules 10a, 10b, 10c, for example, by insulators which are arranged on the connecting levels 8 and may increase their length C in the axial direction X, thus exerting a force in the axial direction on the respectively adjacent modules 10, 10b, 10c of the encapsulation 3. In order to compensate for these forces and in order to fix the position of the modules 10a, 10b, 10c of the encapsulation 3, tie rods 30a, 30b, 30c are attached to the axially adjacent modules 10a, 10b, 10c of the encapsulation 3 of the busbar 2.

The modules 10a, 10b, 10c of the encapsulation 3 are each part of a switch panel of a substation. The separation between the switch panels or the module separation may be governed, for example, by the fixed-position sections of the switch panels. For example, the arrangement shown in FIG. 1 has a first module separation E1 between the first module 10a and the second module 10b, and a second module separation E2 between the second module 10b and the third module 10c. Depending on the embodiment of the GIS, the first module separation E1 is equal to the second module separation E2, as is shown in the figures, or may be different.

The modules 10a, 10b, 10c of the encapsulation 3 have a respective reference point 12a, 12b, 12c. The term reference point is used herein in order to assist understanding. The reference points 12a, 12b, 12c are each a point in or on the respective modules which is held essentially in a fixed position. For example, the reference points 12a, 12b, 12c are kept essentially in a fixed position in three-dimensional space with respect to a foundation 5, in order that the busbar modules 10a, 10b, 10c, and the switch panels associated with them, are not torn out of their anchorage in the foundation 5, or considerable mechanical stresses occur in the switch panels. Depending on the embodiment, the reference point 12a, 12b, 12c is connected to the foundation 5 directly or indirectly, for example, via a high-voltage switch in the switch panel associated with the module. A reference point 12a, 12b, 12c can thus be arranged adjacent to an outgoer of a nominal conductor in the axial direction X, which nominal conductor is passed, for example, to a high-voltage switch.

In the exemplary embodiment shown in FIG. 1, which can be combined with other embodiments, the reference point is arranged in the center of the respective module 10a, 10b, 10c in the axial direction X.

By way of example, the thermal expansion of the encapsulation 3 between the reference points 12a, 12b, 12c and the respective mutually facing ends of the modules 10a, 10b, 10c of the encapsulation 3 can be, in each case, compensated for by a compensation unit 20a, 20b, whose length C is correspondingly shortened in the axial direction X. In other words, a respective section of the encapsulation 3 between the reference points 12a, 12b, 12c and the respective mutually facing ends of the modules 10a, 10b, 10c is lengthened by the respective one section length B2 in the axial direction X, and the axial length C of the compensation unit 20a, 20b is shortened. The compensation unit 20a, 20b is shortened by hollow cylinders which can be pushed partially one over the other, as can be seen schematically in FIG. 1 and FIG. 2. Without a compensation unit 20a, 20b, two adjacent modules 10a, 10b, 10c can be, in each case, forced apart in the event of thermal expansion.

A first tie rod 30a has a first end 36a, which is attached to the first module 10a of the encapsulation 3 at a first attachment point 32a, and a second end 38a, which is attached to the second module 10b of the encapsulation 3 at a second attachment point 34a. Correspondingly, a second tie rod 30b has a first end 36b, which is attached to the second module 10b of the encapsulation 3 at a first attachment point 32b, and a second end 38b, which is attached to the third module 10c of the encapsulation 3 at a second attachment point 34b. Furthermore, a first end 36c of a third tie rod 30c is attached to the third module 10c of the encapsulation 3 at a first attachment point 32c. It is to be noted that the third tie rod 30c is not illustrated completely in FIG. 1. An end of the third tie rod 30c which cannot be seen is attached to a module, which is not shown, of the encapsulation 3.

In the case of a first pair of two axially adjacent modules in the encapsulation 3, which pair are formed from the first module 10a and the second module 10b which are held together via the first tie rod 30a, the attachment points can be arranged as follows. The first module 10a has a section 14F1a, which faces away from the second module 10b, from the reference point 12a of the first module. The first attachment point 32a is arranged on this section 14F1a of the first module. The second module 10b has a section 14F1b, which faces away from the first module 10a, from the reference point 12b of the second module 10b. The second attachment point 34a is arranged on this section 14F1b of the second module.

The attachment points 32b, 34b are arranged in a corresponding manner for a second pair of modules, including the second module 10b and the third module 10c, which are held together via the second tie rod 30b. The second module 10b has a section 14F2a, which faces away from the third module 10c from the reference point 12b of the second module 10b. The first attachment point 32b of the second tie rod 30b is arranged on this section 14F2a. The third module 10c correspondingly has a section 14F2b, which faces away from the second module 10b from the reference point 12c of the third module. The second attachment point 34b of the second tie rod 30b is arranged on this section 14F2b of the third module 10c.

This makes it possible to see the system for length compensation according to the present disclosure, which can in this manner extend over a large number of modules of a busbar 2.

However, the tie rods need not necessarily be attached to the attachment points at their respective ends 36a, 36b, 38a, 38b. The subject matter of the present disclosure relates to the length in the axial direction X of the tie rods 30a, 30b, 30c between the attachment points 32a, 32b, 32c, 34a, 34b in conjunction with the coefficients of linear expansion of the tie rod and of the corresponding length section of the associated module. In FIG. 1, the tie rods each extend over two modules 10a, 10b, 10c, and are attached at the respectively mutually remote ends of the modules of the encapsulation of a busbar via the attachment points 32a, 32b, 32c, 34a, 34b thereto. The thermal expansion of the modules 10a, 10b, 10c of the encapsulation 3 can be compensated for by a suitable tie rod material and suitable attachment points in the axial direction on the modules. Furthermore, the tie rods 30a, 30b, 30c compensate for the force exerted on the modules in the axial direction X from the gas which is located in the compensation units 20a, 20b, although this is minor or even negligible in comparison to the thermal expansion of the modules 10a, 10b, 10c. However, for example, the first tie rod 30a prevents the first and second modules 10a, 10b from being pushed away from one another, and the second tie rod 30b prevents the second and third modules 10b, 10c from being pushed away from one another.

The subsequent mathematical derivation is based on the assumption that the reference points 12a, 12b, 12c are each arranged centrally in the axial direction of the modules 10a, 10b, 10c of the encapsulation of the busbar 2.

The distances are defined as follows and will be explained with reference to the left-hand and central module of the encapsulation 3 in FIG. 1:

A1 is the distance in the axial direction X between the first attachment point 32a and the center of the first module 10a, which corresponds to the first reference point 12a.

A2 is the distance in the axial direction X between the second attachment point 34a and the center of the second module 10b, which corresponds to the second reference point 12b.

The distances relating to the second tie rod 30b, with a length in the axial direction F2 between the first and second attachment points 32b, 34b, are defined as follows:

A3 is the distance in the axial direction X between the first attachment point 32b and the reference point 12b of the second module 10b, and A4 is the distance in the axial direction X between the second attachment point 34b and the reference point 12c of the third module 10c.

In the following, an exemplary embodiment is described for illustrative purposes, in which the distances A1, A3 are equal to the distances A2, A4. These distances are therefore generally annotated A. However, other embodiments are also possible, for which the distance A1 is not equal to A2, and A3 is not equal to A4. This leads only to a more complex mathematical derivation.

Furthermore, a first module separation between the first module 10a and the second module 10b is annotated E1, and a second module separation E2 between the third module 10c and the second module 10b is annotated E2. In order to simplify the following mathematical analyses, it is assumed that the first module separation is equal to the second module separation, and this is therefore annotated, for simplicity, as E. The module separation in general corresponds to the separation between the respective reference points 12a, 12b, 12c of the modules 10a, 10b, 10c of the encapsulation 3 of the busbar 2.

Should one module have more than one reference point, then the reference point which is in each case furthest away from the other module is in each case chosen as the reference point for the distance calculations for analysis of two axially adjacent modules. In the case of reference points which cover an area, the center of the axial direction X is chosen for the calculations of the distances.

The tie rods 30a, 30b respectively have a length between the first and second attachment points 32a, 34a and 32b, 34b of F1, F2. The following analyses are based on the assumption that the length of the tie rods between the attachment points 32a, 32b, 34a, 34b is in each case the same, and this is annotated F.

The length of a module 10a is annotated D. The length of the module is the distance in the axial direction X between the connecting surfaces 8.

Furthermore, the axial length of a section of the first module 10a between its reference point 12a and that end or connecting surface 8 which faces the second module 10b is annotated B1, and the length of a section of the second module 10b between its reference point 12b and that end or connecting surface 8 which faces the first module 10a is annotated B2. For simplicity, the following text is based on the assumption that B1 is equal to B2, and is annotated B.

In accordance with an exemplary embodiment, for illustrative purposes, B1, B2 and/or B correspond/corresponds to half the length of the first or second module 10a, 10b, respectively, in the axial direction X.

The length in the axial direction of the first compensation unit 20a is annotated C.

The relationships between the lengths introduced above in the axial direction X are as follows:

E=C+D (1)

E=F−2A (2)

In this case, the thermal expansion in the axial direction X is:

ΔE=ΔF−2*ΔA (3)

In general, the material and the length of the tie rod are chosen such that the maximum extension ΔE is minimized for all operating states, such that the thermal forces and stresses are minimized.

In one specific case, when ΔE is equal to zero, no forces are transmitted to the foundation in the axial direction. In this case, the compensation unit completely compensates for the lengthening of a module:

ΔD=−ΔC (4)

In other words, the thermal expansion in the axial direction of the modules 10a, 10b of the encapsulation 3 in the respective sections 14F1a, 14F1b between the first and second reference points 12a, 12b and the respective attachment points 32a, 34a is equal to the expansion of the tie rod between the attachment points 32a, 34a. This means that ΔF=2*ΔA and ΔF1=ΔA1+ΔA2, if the distances to the first and second modules are different.

ΔE=0 is achieved if the length and the material of the modules of the encapsulation and of the tie rod or rods are chosen to satisfy the equation:

F=A*2*(α_{A}*ΔT_{A}/α_{F}*ΔT_{F}) (5)

where α_{A} is the thermal coefficient in the expansion, for example, in the axial direction X, of the material of the modules of the encapsulation of the busbar, α_{F} is the thermal coefficient of the expansion, for example, in the axial direction, of the material of the tie rod, ΔT_{A} is the temperature change of the module of the encapsulation, and ΔT_{F} is the temperature change of the encapsulation of the tie rod.

If the module and the tie rod are at the same temperature, equation (5) can be simplified to:

F=A*2*α_{A}/α_{F} (6)

FIG. 2 shows a cross-sectional plan view of an exemplary embodiment of a switchgear assembly 100 having a busbar 102. The same features are annotated with reference numbers and signs incremented numerically by 100, as shown in FIG. 1. Only further features will therefore be described, and references made to FIG. 1 and the associated description for the features which have already been explained.

The modules 110a, 110b, 110c of the encapsulation 103 of the busbar 102 are each T-shaped, in order to allow an outgoer from a nominal conductor 101, which is routed in the modules 110a, 110b, 110c, to individual high-voltage switches, and this is partially routed in outgoer sections 118a, 118b, 118c of the modules 110a, 110b, 110c. The outgoer sections 118a, 118b, 118c may also have different forms. In this case, the center of the tubular outgoer sections 118a, 118b, 118c, which are in each case arranged at right angles to the axial direction X, on the busbar 102 defines the reference points 112a, 112b, 112c of the modules 110a, 110b, 110c of the encapsulation 103. The nominal conductors 101 are held by insulators 109, which are arranged at the ends of the modules 110a, 110b, 110c in the axial direction. Individual gas compartments can therefore also be formed in the gas-insulated switchgear assembly. Pressurized gas in the compensation units 120a, 120b then pushes against the insulators 109, and therefore pushes the modules 110a, 110b, 110c which are adjacent in the axial direction, apart from one another in the axial direction. For illustrative purposes, FIG. 2 only shows a first and a third tie rod. The second tie rod has been omitted from the drawing.

The tie rods 130a, 130b are each attached by means of a nut 140 and the attachment points 132a, 132c, 134a. In this case, the length of the tie rods between the attachment points 132a, 132c, 134a is governed by the stop surfaces of the nuts 140 and the attachment points.

In accordance with an embodiment, the tie rods can be arranged above (with respect to the force of gravity) the encapsulation of the busbar with the modules. The air which has been heated by the modules flows upward, and keeps the tie rods essentially at the same temperature as the encapsulation of the modules. In accordance with an exemplary embodiment, plates can be arranged on the outer surface of the encapsulation, in order to emit heat, and to bring the tie rods to a similar temperature to that of the encapsulation. In accordance with an exemplary embodiment, a steel with low magnetization losses can be used as the material, in order to match the temperatures of the tie rod and the encapsulation.

In accordance with an exemplary embodiment, the change in the module separation ΔE is kept equal to zero. The length of a module is D=1.5 m. The length of a compensation unit is C=0.3 m. The module width is E=1.8 m.

Electrical aluminum for which α_{A}=23.8 E−6/K is chosen for the encapsulation.

A ferritic steel for which α_{F}=10.5 E−6/K is chosen for the tie rods.

The tie rods should have an axial length F=3.2 m between the first attachment point and the second attachment point.

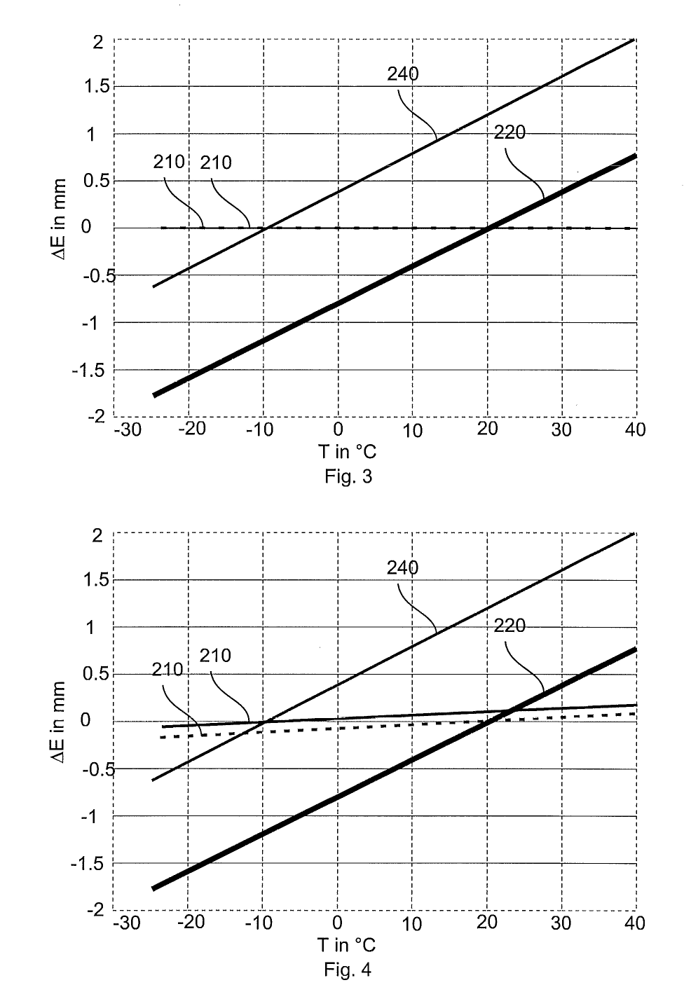

For the first example and the calculated tie rod length of F=3.2 m, FIG. 3 shows the comparison of the thermal expansion corresponding to the disclosure (line 210, shown in bold) and in the conventional technique (220), where a tie rod is attached to both ends of a compensation unit. The ambient temperature T is arranged on the abscissa axis, and the change in the module separation ΔE is shown on the ordinate axis. The graphs take account of the fact that the tie rods were attached to the modules of the encapsulation and compensation units at an ambient temperature T of 20° C. The line 220 therefore intersects the zero point at 20° C., and the expansion or change in the module separation ΔE is zero at 20° C.

Furthermore, the graphs show the expansion of the module separation ΔE during operation of the modules, that is to say when a maximum permissible current is flowing through the modules. This leads to heating of approximately 30K. The thermal expansion according to an exemplary embodiment of the present disclosure always remains zero (see the line 230) while, in contrast, in the conventional technique, the thermal expansion is more than 1 mm even at 20° C. (see the line 240).

FIG. 3 therefore shows that the module separation for exemplary embodiments according to the present disclosure remains essentially constant, that is to say the lengthening of the module in the axial direction has been compensated for by the axial expansion of the tie rod.

The length of the tie rod F between the first and the second attachment points is greater than the module separation, and the distance between the points E, which must be held in a fixed position, of the modules or busbar modules, if the coefficient of expansion of the material of the tie rod is less than the coefficient of expansion of the material of the module.

A further case will be explained using a second example. The dimensions used are the same as those as in the first example:

The length of a module of the encapsulation is D=1.5 m. The length of a compensation unit is C=0.3 m. The module width is E=1.8 m.

Electrical aluminum for which α_{A}=23.8 E−6/K is chosen for the encapsulation.

A steel for which α_{F}=12.5 E−6/K is chosen for the tie rods.

Complete compensation is impossible with the given dimensions. Nevertheless, a significant and adequate reduction in the thermal expansion of the module separation is achieved with the same tie rod length (F=3.2 m), as is shown in FIG. 4. The same graphs are annotated with the same reference numbers as in FIG. 3.

The lines 210 and 220 intersect the zero point at 20° C., since the tie rods are fitted to the modules of the encapsulation at 20° C.

For the second example and the calculated tie rod length of F=3.2 m, FIG. 4 shows the comparison of the thermal expansion corresponding to the disclosure (line 210, shown in bold) and in the conventional technique (220), where a tie rod is attached to both ends of a compensation unit. The ambient temperature T is arranged on the abscissa axis, and the change in the module separation ΔE is shown on the ordinate axis. The graphs take account of the fact that the tie rods were attached to the busbar modules and compensation units at an ambient temperature of 20° C. The line 220 therefore intersects the zero point at 20° C., and the expansion of the module separation ΔE is zero at 20° C.

Furthermore, the graphs show the expansion of the module separation during operation of the modules, that is to say when a maximum permissible current is flowing through the modules. This leads to heating of approximately 30K. According to one embodiment of the disclosure, the thermal expansion always remains less than 0.5 mm (see the line 230) while, in contrast, in the conventional technique, the thermal expansion is more than 1 mm even at 20° C. (see the line 240).

In other words, it is possible by choice of the materials of the tie rods and of the encapsulation, and by the correct choice of the attachment points, to compensate for the thermal expansion of the modules of the encapsulation in the case of a linear form of a busbar, such that the module separation remains essentially the same.

The features of the present disclosure described above, in the claims and in the drawings can be significant for implementation of the various embodiments of the disclosure both individually and in any desired combination.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### LIST OF REFERENCE SYMBOLS

1 Switchgear assembly
2 Busbar
3 Encapsulation
5 Foundation
8 Connecting levels
10a, 10b, 10c Module
12a, 12b, 12c Reference point
14F1a, 14F1b Section
14F2a, 14F2b Section
16 Flange
20a, 20b Compensation unit
26 Flange
30a, 30b, 30c Tie rod
32a, 32b, 32c First attachment point
34a, 34b Second attachment point
36a, 36b, 36c First end
38a, 38b Second end
100 Switchgear assembly
101 Nominal conductor
102 Busbar
103 Encapsulation
108 Connecting level
109 Insulator
110a, 110b, 110c Module
112a, 112b, 112c Reference point
114F1a, 114F1b Section
116 Flange
118a, 118b, 118c Outgoer section
120a, 120b Compensation unit
126 Flange
130a, 130c Tie rod
132a, 132c First attachment point
134a Second attachment point
136a, 136c First end
138a Second end
140 Attachment nut
A1, A2, A3, A4 Axial distance between the reference point and the attachment point
B1, B2 Section length
C Compensation unit length
D Module length
E1, E2 Module separation
F1, F2 Effective tie rod length
T Ambient temperature
X Axis

What is claimed is:

1. A gas-insulated switchgear assembly comprising:
at least one busbar for transmission of electrical primary power, wherein the busbar defines an axial direction and includes an encapsulation which surrounds at least one nominal conductor, wherein the encapsulation includes:
at least one pair of axially adjacent modules of which a first module of the pair of axially adjacent modules has a first reference point in the axial direction, and a second module of the pair of axially adjacent modules has a second reference point in the axial direction;
a compensation unit which is arranged between each of the modules of the pair of axially adjacent modules;
a module separation which is defined by the axial distance between the first reference point and the second reference point of the respective pair of axially adjacent modules; and
at least one tie rod which is associated with the pair of axially adjacent modules and extends in the axial direction, wherein:
the at least one tie rod is attached at a first attachment point to the first module and at a second attachment point to the second module, and has a length in the axial direction which extends between the first attachment point and the second attachment point; and
the at least one tie rod is configured to axially expand to at least partially compensate for any lengthening of the modules in the axial direction when the encapsulation is heated or cooled, due to the length of the at least one tie rod and a coefficient of linear expansion of the at least one tie rod in conjunction with a first distance which extends in the axial direction between the first attachment point and the first reference point of the first module, and a second distance which extends in the axial direction between the second attachment point and the second reference point of the second module, as well as coefficients of linear expansion of the adjacent modules.

2. The gas-insulated switchgear assembly as claimed in claim 1, wherein the length of the at least one tie rod associated with the pair in the axial direction between the first and the second attachment points is greater than a module separation of the pair.

3. The gas-insulated switchgear assembly as claimed in claim 1, wherein the module separation is configured to change by less than a predetermined amount in the axial direction when the encapsulation is heated or cooled.

4. The gas-insulated switchgear assembly as claimed in claim 1, wherein at least one material of the encapsulation, which contributes to the thermal expansion in the axial direction, of the encapsulation and at least one material of the tie rod, which contributes to the thermal expansion in the axial direction, of the tie rod are structured such that, when the encapsulation and the tie rod are heated by 50° Celsius, the module separation changes by less than 1%.

5. The gas-insulated switchgear assembly as claimed in claim 1, wherein thermal expansion in the axial direction of the encapsulation between the first reference point and the first attachment point, and between the second reference point and the second attachment point, and thermal expansion in the axial direction of the at least one tie rod between the first and the second attachment points are compensated for such that, when heated by 50° Celsius, the module separation changes by less than 1%.

6. The gas-insulated switchgear assembly as claimed in claim 1, wherein the modules of the pair each have an axial section, which is averted from their reference point on the compensation unit, wherein each of the at least one tie rod is attached to one of the axial section and the reference point at an attachment point, respectively.

7. The gas-insulated switchgear assembly as claimed in claim 1, wherein the at least one tie rod is arranged outside a gas area of the first module and the second module of the pair of axially adjacent modules.

8. The gas-insulated switchgear assembly as claimed in claim 1, wherein at least one of the attachment points is arranged at an axial end of the respective module of the encapsulation.

9. The gas-insulated switchgear assembly as claimed in claim 1, wherein the first distance between the first attachment point and the first reference point of the first module, and the second distance between the second attachment point and the second reference point of the second module are the same.

10. The gas-insulated switchgear assembly as claimed in claim 1, wherein the modules are connected in a fixed position to a foundation in an area of the reference points, respectively.

11. The gas-insulated switchgear assembly as claimed in claim 1, wherein the modules include at least one switch.

12. The gas-insulated switchgear assembly as claimed in claim 1, wherein gas in at least one of (i) the first and second modules of the at least one pair of axially adjacent modules and (ii) the compensation unit is at a pressure of more than 2.5 bar, in particular of more than 4 bar, at 20° C.

13. The gas-insulated switchgear assembly as claimed in claim 1, wherein at least one of the first module and second module of the at least one pair of axially adjacent modules comprises aluminum which contributes to the change in the length in the axial direction.

14. The gas-insulated switchgear assembly as claimed in claim 1, wherein the at least one tie rod is at least partially of composite design, and
wherein a composite section contributes to the compensation for the thermal change in the length in the axial direction.

15. The gas-insulated switchgear assembly as claimed in claim 1, wherein the at least one tie rod is comprised of steel which contributes to the compensation for the thermal change in the length in the axial direction.

16. The gas-insulated switchgear assembly as claimed in claim 1, wherein the at least one compensation unit is configured to compensate for an axial thermal length change of at least one module section, which faces the reference point, of the modules of the pair relative to one another.

17. A gas-insulated substation comprising the gas-insulated switchgear assembly as claimed in claim 1, wherein the gas-insulated switchgear assembly includes more than two modules which are arranged axially one behind the other, such that two axially adjacent modules in each case form a pair.

18. The gas-insulated switchgear assembly as claimed in claim 2, wherein the module separation is configured to change by less than a predetermined amount in the axial direction when the encapsulation is heated or cooled.

19. The gas-insulated switchgear assembly as claimed in claim 18, wherein at least one material of the encapsulation, which contributes to the thermal expansion in the axial direction, of the encapsulation and at least one material of the tie rod, which contributes to the thermal expansion in the axial direction, of the tie rod are structured such that, when the encapsulation and the tie rod are heated by 50° Celsius, the module separation changes by less than 0.5%.

20. The gas-insulated switchgear assembly as claimed in claim 18, wherein thermal expansion in the axial direction of the encapsulation between the first reference point and the first attachment point, and between the second reference point and the second attachment point, and thermal expansion in the axial direction of the at least one tie rod between the first and the second attachment points are compensated for such that, when heated by 50° Celsius, the module separation changes by less than 0.5%.

21. The gas-insulated switchgear assembly as claimed in claim 5, wherein at least one of the attachment points is arranged at an axial end of the respective module of the encapsulation.

22. The gas-insulated switchgear assembly as claimed in claim 5, wherein the first distance between the first attachment point and the first reference point of the first module, and the second distance between the second attachment point and the second reference point of the second module are the same.

23. The gas-insulated switchgear assembly as claimed in claim 8, wherein the first distance between the first attachment point and the first reference point of the first module, and the second distance between the second attachment point and the second reference point of the second module are the same.

24. The gas-insulated switchgear assembly as claimed in claim 12, wherein the gas in at least one of (i) the first and second modules of the at least one pair of axially adjacent modules and (ii) the compensation unit is at a pressure of more than 4 bar, at 20° C.

25. The gas-insulated switchgear assembly as claimed in claim 7, wherein gas in at least one of (i) the first and second modules of the at least one pair of axially adjacent modules and (ii) the compensation unit is at a pressure of more than 2.5 bar, at 20° C.

26. The gas-insulated switchgear assembly as claimed in claim 20, wherein at least one of the first module and second module of the at least one pair of axially adjacent modules comprises aluminum which contributes to the change in the length in the axial direction.

27. The gas-insulated switchgear assembly as claimed in claim 20, wherein the at least one tie rod is at least partially of composite design, and
wherein a composite section contributes to the compensation for the thermal change in the length in the axial direction.

28. The gas-insulated switchgear assembly as claimed in claim 20, wherein the at least one tie rod is comprised of steel which contributes to the compensation for the thermal change in the length in the axial direction.

29. The gas-insulated switchgear assembly as claimed in claim 6, wherein the at least one compensation unit is configured to compensate for an axial thermal length change of at least one module section, which faces the reference point, of the modules of the pair relative to one another.
